(19) United States
(12) Patent Application Publication
(10) Pub. No.: US 2013/0087382 A1
(43) Pub. Date: Apr. 11, 2013

(54) FLOATING POWER CABLE WITH LOW-FRICTION SURFACE FOR SWIMMING POOL CLEANERS

(71) Applicant: Giora ERLICH, North Caldwell, NJ (US)

(72) Inventor: Giora ERLICH, North Caldwell, NJ (US)

(21) Appl. No.: 13/267,195

(22) Filed: Oct. 6, 2011

(51) Int. Cl. H02G 15/02; H01R 43/00

(52) U.S. Cl. 174/74 A; 29/825

(57) ABSTRACT

A buoyant power cable for electrically connecting a submerged robotic self-propelled pool cleaner to an external power supply that is subject to foaming coils in the floating portion that are not readily opened and interfere with the desired movement of the pool cleaner is provided with a separate flexible sleeve of polymeric material or an extruded coating of a foamable or solid polymeric composition having a relatively low coefficient of friction as compared to the surface of the floating cable over the portion of the cable that floats on the water's surface so that when one or more loops are formed in a portion of the cable covered by the sleeve or coating, the contacting surfaces easily slide over each other to permit the removal of the loops and the free movement of the pool cleaner.

### RELATED APPLICATIONS

None

### FIELD OF THE INVENTION

The invention relates to floating power cables used with robotic self-propelled pool cleaners.

### BACKGROUND OF THE INVENTION

Robotic swimming pool cleaners receive electrical energy from a remote power source that is external to the pool through a buoyant or floating power cable. The electrical conductors are encased in a foamed rubber or other polymeric composition that renders the assembly buoyant. As the pool cleaner traverses the bottom surface in a pre-programmed and/or random pattern, the portion of the cable that is floating on the surface of the water can form loops. At the point of contact between the opposing surfaces of the cable, the coefficient of friction is sufficiently high to preclude sliding movement, even though the area of contact is relatively small. As a number of loops are formed, the tendency of the power cable to restrict the movement of the submerged pool cleaner increases to the extent that it interferes with the desired cleaning pattern or even the random movement of the pool cleaner.

As used herein, the terms “coefficient of friction”, “coefficient of friction value” and “COF” are used to refer to the empirically determined property of the contracting materials that is represented by the factor μ in the well-established expression:

F_{f}≦μFₙ

Where F_{f} is either the force exerted by friction, or in the case of equality, the maximum possible magnitude of this force, and Fₙ is the normal force exerted between the surfaces. If the surfaces are at rest relative to each other, μ is represented by Mₛ, where Mₛ is the coefficient of static friction, and Mₛ is typically greater than its kinetic counterpart. The value of the coefficient of static friction must be determined empirically and is typically lower for the same materials if the surfaces are wet with water as compared to being dry.

It would therefore be desirable to provide some means for reducing the coefficient of friction between the portions of a pool cleaner's power cable so that any loops formed could be easily removed or displaced by the forces applied to the cable by the normal movement of the submerged pool cleaner.

Conversely, it would be desirable to minimize the drag or resistive force experienced by the pool cleaner as a result of the forces exerted by the floating and submerged portions of the power cable.

It would also be highly desirable to provide such a friction-reducing means that can be used with existing power cables and that can be easily applied by the pool cleaner owner without the assistance of a trained technician.

It would also be desirable to provide a floating power cable as original equipment, or for sale as a replacement, that was manufactured with an integral surface or surface coating that exhibited a low coefficient of friction.

### SUMMARY OF THE INVENTION

In one embodiment of the patent invention, a separate flexible sleeve of polymeric material having a relatively low coefficient of friction as compared to the surface of the floating cable is provided and installed to surround substantially the entire length of the portion of the cable that floats on the water's surface. The sleeve is sufficiently flexible to permit the natural movement of the buoyant cable. When a loop is formed in a portion of the cable covered by the sleeve, the contacting surfaces of the sleeve easily slide over each other to permit the free movement of the power cable to open or remove the loop and thereby, permit the free movement of the pool cleaner over which the sheathed cable is placed. In a preferred embodiment, the overall length of the sleeve and its dimensions are sufficient to maintain the sleeve in the desired position on the cable.

Alternatively, one or more clips can be attached to the cable and/or the sleeve to secure the sleeve in a predetermined position on the cable.

For the purposes of the present description of the invention and the claims, it is to be understood that the absolute or specific values of the coefficient of friction between the (1) the surfaces of the power cable and (2) the surfaces of the flexible sleeve are of less importance than the selection of a sleeve that exhibits a COF value that is relatively lower than the value of the COF for the power cable in static contact with itself.

Empirical determination of these relative values can be undertaken using relatively simple apparatus and methods of making such physical measurements that are known to those of ordinary skill in the art.

In a preferred embodiment, the sleeve is split along its entire length to facilitate its placement on the power cable. In a particularly preferred embodiment, the sleeve or sheath has a corrugated surface, thereby reducing the surface area during contact with itself when a loop is formed and when withdrawn by the tension on the power cable as transmitted from the moving pool cleaner. The corrugated, or ribbed, or ridged surface of the low-friction sleeve also permits the sleeve to easily bend and flex to the same extent as the power cable.

In an especially preferred embodiment, the inside diameter of the sleeve is sufficiently greater than the outside diameter of the power cable to permit the power cable and sleeve to turn independently of each other.

Since the power supply/transformer is typically placed at some distance from the edge of the pool for safety reasons and for access to a 110 volt electric power source, the sleeve need only cover so much of the power cable as is likely to form loops when it is floating on the surface of the pool. Experience indicates that the sleeve, as described in more detail below, will maintain its desired position relative to the portion of the power cable floating on the surface, so that no special clips or other fasteners need be provided between the sleeve and the power cable.

Importantly, the sleeve or sheathing for the power cable can be easily coiled and compactly packaged either separately for sale by pool cleaner retailers, or installed on the power cable and packaged with the pool cleaner for shipment and supplied as original equipment.

Suitable materials for use in the practice of the invention are readily available in a variety of sizes and colors and are economical to manufacture and purchase. Corrugated sleeves such as those used for protecting and forming automotive and other electrical wiring are particularly suitable for use in the present invention. They are available from various suppliers as a staple item of commerce.

Sleeves or sheaths can also be fabricated from woven and nonwoven materials in the form of sheets or webs that can be cut and bonded along their opposing edges to form a cylinder that is placed over the cable. Such sleeves can be fabricated from a shrink-wrap polymer that is placed over the buoyant power cable and heated to produce a close-fitting smooth surface of the desired lower COF value. Suitable fibers include olefins, such as polyethylene and polypropylene.

In a second embodiment of the invention, the power cable is fabricated from a polymer that exhibits a coefficient of friction that is sufficiently low enough to avoid the problems associated with the floating power cables of the prior art. A polymer having the desired lower COF when cured is applied by extrusion either as a solid coating or film, or as a foamable composition that expands to provide a buoyant coating. The solid extrusion can be applied directly to the exterior of a floating cable of the prior art by passing the cable through the center of the die and extruding the desired polymer coating onto its surface to provide an integral laminated structure.

In an alternative embodiment, the electrical conductors, which themselves are provided with an integral dielectric insulating covering, are covered in an extrusion process with a foamable polymeric composition which, when cured or post-treated, has an outer surface or skin that exhibits the desired lower COF value.

In yet a further embodiment, an existing floating power cable of the prior art is coated with a platisol or liquid polymer material, as by dipping or spraying, that cures to form a tough flexible, smooth and uniform coating having the desired lower COF value.

### BRIEF DESCRIPTION OF THE DRAWINGS

The invention will be further described in detail and with reference to the attached drawings in which the same or similar elements are identified by the same numeral, and where:

FIG. 1 is a perspective view of a power cable which electrically connects a power supply to a submerged pool cleaner, wherein the power cable is surrounded by a flexible sleeve in accordance with the present invention;

FIG. 2 is a top view of a portion of the flexible sleeve floating on the surface of the water according to FIG. 1 which has formed a plurality of loops;

FIG. 3 is a cross-sectional view of the power cable surrounded by the flexible sleeve taken along line 3-3 of FIG. 2;

FIG. 4 is a perspective of an overlapping section of the power cable surrounded by the flexible sleeve according to FIG. 1; and

FIG. 5 is a cross-sectional view of the power cable surrounded by the flexible sleeve taken along line 5-5 of FIG. 4.

### DETAILED DESCRIPTION OF THE INVENTION

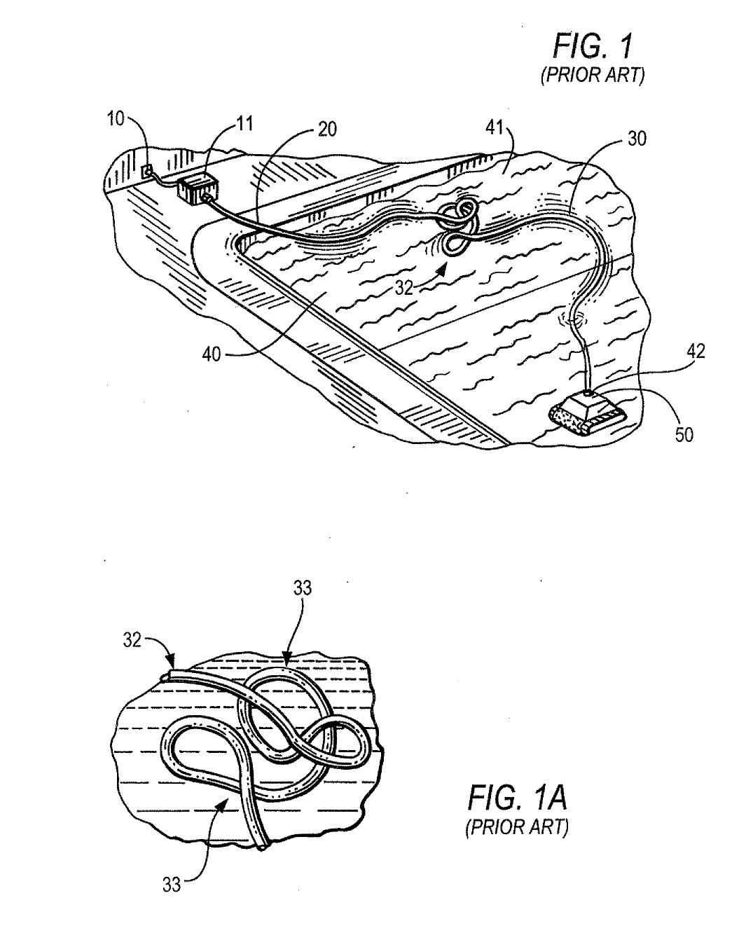

A first embodiment of the present invention will be described with reference to FIGS. 1-5. Referring to FIG. 1, a power cable 20 is shown which electrically connects a power supply 10 to a pool cleaner 50. The pool cleaner 50 is a robotic self-propelled pool cleaner that is submerged in the pool water 40 and traverses the bottom surface in a pre-programmed and/or random pattern. In one embodiment, a transformer 11 can provide intermediate connection from the power supply 10 to the power cable 20.

The power cable 20 generally includes a buoyant material which causes a portion of the power cable 20 to float on the surface 41 of the water 40. However, its attachment to the submerged pool cleaner 50 causes a portion of the power cable to become submerged starting, e.g., at a location 42 along the power cable 20 which is dependent on the depth of the pool cleaner 50 below the surface.

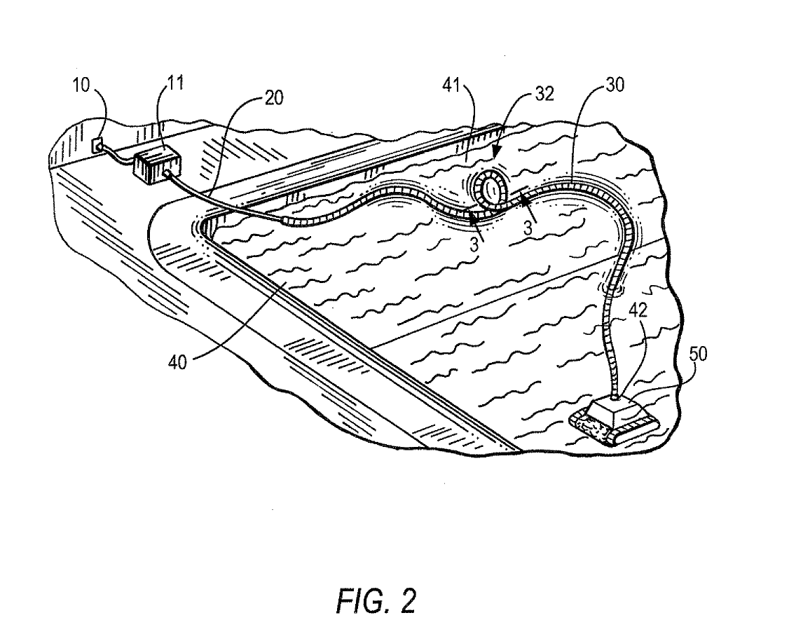

Typically, pool cleaners or at least their associated power cables are removed from the pool and placed poolside while bathers are using the pool. Often the power cable is coiled or randomly gathered up onto itself before it is placed on the ground. Thereafter, after the bathers have left the pool, the power cord 20 will be picked up from poolside and dropped it back into the water 40 along with the submerged pool cleaner 50. FIG. 1 represents an example of an initial condition in which the user has dropped the coiled power cord 20 back into the water 40. As shown in FIGS. 1 and 2, the power cord 20 can sometimes remain bunched up and coiled over itself while it floats on the surface 41 of the water, forming a plurality of overlapping loops 32.

The overlapping loops 32 can create a problem if they do not open or unravel on their own. That is, if the force created by the pool cleaner 50 is not sufficient to open the overlapping loops 32, the foreshortened cable will restrain the free movement of the pool cleaner and it will not be able to traverse the entire bottom surface of the pool in accordance with its programmed or random mode of movement. This particular problem is often encountered when using typical prior art power cables 20 because of the relatively high coefficient of static friction that exists between opposing surfaces of the power cable 20 along the overlapping sections 33.

In accordance with the present invention, the power cable 20 is surrounded by a separate flexible sleeve 30. The invention provides a relatively simple and effective solution to the coiling problem by providing a separate, generally cylindrical flexible sleeve 30 that surrounds at least a portion of the power cable 20 that is floating on the surface of the pool during operation of the submerged pool cleaner. The coefficient of static friction of the surface of the sleeve on the sleeve is less than the coefficient of static friction of the surface of the power cable on the power cable. Because of the generally lower coefficient of friction, the opposing outer surfaces of the sleeve can easily slide over each other enabling the loops to be opened and the power cable to be extended to substantially its full length. Any loops 32 formed in the power cable and surrounding sleeve can be overcome by the force generated by the normal movement of the pool cleaner without substantially interfering with the travel pattern of the pool cleaner.

In one embodiment, the sleeve material can be an impact-resistant polymeric material. In a preferred embodiment, the sleeve is fabricated as a shape memory material. In an embodiment, the entire sleeve, or at least the outer surface of the sleeve can include a polytetrafluoroethylene (PTFE) coating which has a coefficient of static friction on itself of 0.04.

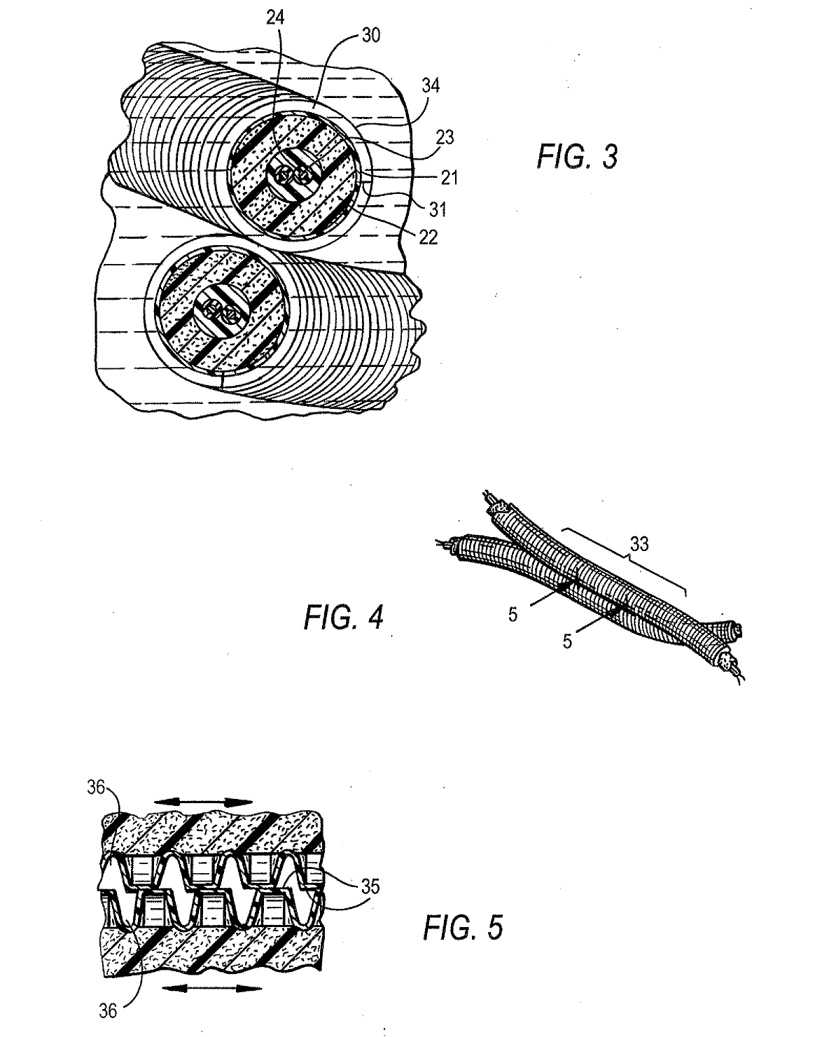

FIG. 3 shows a cross-sectional view of the power cable of the prior art surrounded by the flexible sleeve taken along line 3-3 of FIG. 2. The power cable 20 includes electrical conductors 23 encased within a central core 24. The electrical conductors 23 are adapted to carry electricity from the power supply 10 to the pool cleaner 50. An annular layer of porous material, e.g., an open or closed cell foam material 22 surrounds the central core 24. The porous material 22 can include a plurality of air pockets which renders it buoyant and causes the power cable to float when placed in the pool water 40. As discussed above, a separate, generally cylindrical flexible sleeve 30 surrounds the surface 21 of the buoyant power cable. The flexible sleeve 30 can be split along its entire length, as shown at 31, to facilitate its placement on the power cable. For example, the adjacent opposing edges of the split sleeve can be spread apart to receive the portion of the length of the power cable to be covered. As shown in FIG. 3, the flexible sleeve 30 can engage the surface 21 of the power cable in close-fitting relation. In another embodiment, the inside diameter of the sleeve can be sufficiently greater than the outside diameter of the power cable to permit the power cable and sleeve to turn independently of each other.

FIG. 4 shows a perspective view of an overlapping section of the power cable surrounded by the flexible sleeve according to FIG. 1. Because the coefficient of friction of the sleeve 30 is relatively lower than the coefficient of friction of the power cable 20, the contacting portions of the sleeve 30 can easily slide over each other, as discussed further below.

FIG. 5 shows a cross-sectional view of the power cable surrounded by the flexible sleeve taken along line 5-5 of FIG. 4. In the embodiment shown, the sleeve 30 is formed with a plurality of spaced-apart ridges 35. The ridges 35 can be evenly spaced apart. The outermost surface of the ridges 35 can be flat. In other embodiments, the outermost surface of the ridges can be curved or can have irregular surfaces. In an especially preferred embodiment, the outermost surface of each of the ridges has a uniform diameter. As shown in the embodiment depicted by FIG. 5, the sleeve can be formed with a plurality of alternating parallel ridges 35 and grooves 36. Preferably, the width of the ridges 35 is greater than the width of the grooves 36 in order to prevent the ridges 35 from interlocking with the grooves 36 along opposing surfaces. For example, the width of the ridges 35 can be about 2 mm and the width of the grooves 36 can be about 1 mm. The plurality of ridges and grooves provide a surface having a reduced outermost surface area, which helps to enable the sections of the sleeve to easily slide against itself. In an alternative embodiment, the outermost surface of the sleeve can be ribbed.

A method of using the sleeve according to the present invention is described below. The flexible sleeve is used to lower the coefficient of static friction of a length of buoyant power cable 20 in contact with itself and attached to a robotic self-propelled pool cleaner 50. The flexible sleeve 30 is positioned around a length of the power cable 20 that will be floating on the surface of the pool. The material of the flexible sleeve 30 exhibits a relatively low coefficient of static friction value in contact with itself. When a loop is formed in the power cable 20, the static frictional force of the opposing outer surfaces of the flexible sleeve 30 is overcome by the forces generated by the pool cleaning device 50 and opens or unravels the loop without substantial disruption of the pool cleaner's intended travel pattern. In a preferred embodiment, the method is used to lower the coefficient of friction of the floating portion of the buoyant power cable that extends between the submerged pool cleaner 50 and a remote external power supply 10. In one embodiment, the power cable 20 is positioned entirely within the interior space defined by the sleeve 30.

In another embodiment (not shown), an integral buoyant covering having a surface exhibiting a relatively low coefficient of friction can be formed, e.g., by extrusion, directly over the insulated conductors. The extruded covering can be produced from any of a variety of foamable polymeric compositions, including polytetrafluoroethylene (PTFE), a copolymer of hexafluoropropylene and tetrafluoroethylene, polyethylene terephthalate (PET), polybutylene terephthalate (PBT), and polyetherimide (PEI). Each of these polymers has a relatively low coefficient of friction and can be extruded onto a substrate in the form of a foam that will impart buoyancy to the finished cable.

A PTFE foamable composition can also be extruded over two or more insulated electrical conductors that are passed through the center of the extrusion die. The finished product is a buoyant cable with a desired relatively low COF value that will permit loops and coils to be straightened by the force of the moving pool cleaner.

In another embodiment, a PTFE foamable composition can be extruded over a floating power cable of the prior art that exhibits a high coefficient of friction. See, for example, U.S. Pat. No. 6,683,255 to Kolmschlag et al. which discloses a method of extruding a hot-melt processable fluoropolymer, in particular, PTFE together with a foaming agent, to provide an open cell foam covering over the central wires or cable. The open cell foam is converted to PTFE with a closed cell sealed surface by sintering, which also produces a slight reduction in the diameter of the finished product. The result is a durable closed-pore foam surface which protects the dielectric against dirt, dust and liquid substances so that its quality is maintained in the long term. The PTFE foam is also flexible and dimensionally stable, which enables it to be used as a floating power cable for swimming pool cleaners. The disclosure of U.S. Pat. No. 6,683,255 is incorporated herein by reference.

In an embodiment, a low-friction flexible polymer coating (non-foamable) can be extruded directly onto the surface of an existing floating power cable of the prior art. See, for example, “Industrial Plastics: Theory and Applications (4^{th} Edition)” by Richardson et al., pages 194-195, which discloses the processes of extrusion coating and wire covering. Richardson et al. disclose that in wire and cable covering, the substrate for extrusion coating is wire. During the process for extrusion coating of wire and cable, a molten plastic is forced around the wire or cable as it passes through the die. The die controls the diameter and forms the coating on the wire. Wires and cables are usually heated before coating to remove moisture and ensure adhesion. It should be noted that for use with the present invention, the extrusion temperature for the coating material would have to be below the decomposition temperature of the pre-formed floating power cable containing the electrical conductors. As the coated product emerges from the crosshead die, it is cooled in a water bath.

In yet a further embodiment, an existing floating power cable of the prior art is coated with a platisol or liquid polymer material, as by dipping or spraying, that cures to form a tough flexible, smooth and uniform coating having the desired lower COF value. The compatibility of the solvent and/or other components of the liquid or spray compositions with the underlying polymer of the floating cable can readily be determined by simple tests or from standard references.

Although the particular embodiments of the method of the present invention have been described in detail, it will be understood that various omissions, modifications, substitutions and changes in the forms and details of the device illustrated and in the methods of application can be made by those of ordinary skill in the art based on this description and the scope of protection for the invention is to be determined by the claims that follow.

I claim:

1. An apparatus for electrically connecting a submerged robotic self-propelled pool cleaner to an external power supply comprising:
a length of buoyant power cable having an outer layer composed of insulative polymer, and
a separate, generally cylindrical flexible sleeve covering at least a portion of the power cable floating on the surface of the water, wherein the value of the coefficient of static friction of the surface of the sleeve on the sleeve is less than the value of the coefficient of static friction of the surface of the power cable on itself, such that any loops formed in the sleeve-covered power cable can be opened by the forces generated by the normal movement of the submerged pool cleaner without substantially interfering with the travel pattern of the pool cleaner.

2. The apparatus of claim 1, wherein the surrounding sleeve engages the power cable in close-fitting relation.

3. The apparatus of claim 1, wherein the sleeve fits loosely on the power cable, thereby allowing the power cable to rotate inside of the sleeve.

4. The apparatus of claim 1, wherein the sleeve is composed of a shape memory retaining material.

5. The apparatus of claim 1, wherein the sleeve is split along its entire length to facilitate its installation over an intermediate portion of the power cable.

6. The apparatus of claim 1, wherein the sleeve is formed from an impact-resistant polymeric material.

7. The apparatus of claim 1, wherein at least the outer surface of the sleeve includes polytetrafluoroethylene (PTFE).

8. The apparatus of claim 1, wherein the sleeve is formed with a plurality of spaced-apart ridges and grooves extending generally radially from the longitudinal axis of the sleeve.

9. The apparatus of claim 8, wherein the width of each ridge is about 2 mm and the width of the grooves is about 1 mm.

10. A power cable for electrically connecting a submerged robotic self-propelled pool cleaner to an external power supply comprising:
at least two electrical conductors;
an extruded foamed polymer layer surrounding the electrical conductors and of a thickness that is sufficient to render the power cable buoyant in fresh water, the polymer being selected to provide the coefficient of static friction of the surface of the polymer layer on the polymer layer of a value such that any loops formed in the power cable floating on the surface of the water in the pool can be removed by the force generated by the normal movement of the submerged pool cleaner, thereby enabling the opposing outer surfaces of the polymer layer to slide against one another to open the loops without substantially interfering with the travel pattern of the pool cleaner.

11. The apparatus of claim 10, wherein the polymer is selected from the group consisting of PTFE, PET, PBT and PEI.

12. A method of lowering the value of the coefficient of static friction of a length of buoyant power cable in contact with itself when attached to a submerged robotic self propelled pool cleaner, the power cable having two or more centrally positioned insulated conductors surrounded by an insulative polymeric outer layer, the method comprising:
providing the surface of at least a portion of the power cable with a flexible covering of polymeric material having a lower coefficient of static friction value for the covering on itself than the value of the coefficient of the static friction of the power cable on itself, whereby the static frictional force between the opposing outer surfaces of the flexible sleeve when a loop is formed in the power cable are overcome by forces generated by the pool cleaner to unravel the loop without substantial disruption of the pool cleaner's intended travel pattern.

13. The method of claim 12, wherein the flexible covering is a separate preformed sleeve that is manually placed over the power cable.

14. The method of claim 12, wherein the flexible covering is extruded onto the surface of the power cable.

15. The method of claim 14, wherein the extruded flexible covering is applied as a foamable composition and is cured to form an expanded foam layer bonded to the surface of the power cable.

16. The method of claim 15 which includes the further step of sintering the surface of the expanded foam layer.

17. The method of claim 12, wherein the flexible covering is applied by dip-coating or spraying.

18. A method of eliminating or minimizing the formation of a plurality of loops and coils in the water-borne portion of a buoyant power cable extending between a submerged robotic pool cleaner and a remote external power supply, the method comprising providing a flexible covering to at least a portion of the length of the power cable, the value of the coefficient of static friction as measured between contacting surfaces of the covering being less than the value of the coefficient of static friction as measured between water-borne contacting surfaces of the power cable.

19. The method of claim 18, wherein the flexible covering is a generally cylindrical elongated sleeve fabricated from impact-resistant polymeric material that is fitted around the power cable.

20. The method of claim 18, wherein the surface of the sleeve is split along its entire length, and the method includes:
a. spreading the adjacent opposing edges of the split sleeve apart to receive the portion of the length of the power cable that is borne on the surface of the water during operation of the pool cleaner.
b. positioning the power cable entirely within the interior space defined by the sleeve, and
c. releasing the opposing edges of the sleeve,
whereby the edges of the split sleeve return to a close-fitting opposed relation along the covered portion of the power cable.
